(19) United States
(12) Patent Application Publication
(10) Pub. No.: US 2005/0281179 A1
(43) Pub. Date: Dec. 22, 2005

(54) Apparatus for optical disc spin-coating

(76) Inventors: Tae-Sik Kang, Daejeon-city (KR); Mi Young Han, Daejeon-city (KR); Seongkeun Lee, Daejeon-city (KR); Sung Hoon Jang, Daejeon-city (KR); Hun Seo, Seongnam-city (KR); Kwang Lyul Lee, Seoul (KR); Youngjun Hong, Daejeon-city (KR)

Correspondence Address: MCKENNA LONG & ALDRIDGE LLP, 1900 K STREET, NW, WASHINGTON, DC, 20006, US

(21) Appl. No.: 11/154,662

(22) Filed: Jun. 17, 2005

(30) Foreign Application Priority Data
Jun. 18, 2004 (KR) 10-2004-0045475

(51) Int. Cl. G11B 7/00

(52) U.S. Cl. 369/275.1; 369/112.24

(57) ABSTRACT

The present invention provides an apparatus for optical disc spin-coating that prevents leakage of a photocurable resin due to a capillary phenomenon by controlling a contact area between a cap and a disc so that contamination of the disc and manufacturing errors do not occur. Furthermore, the apparatus of the present invention can manufacture an optical disc having a central portion which is not contaminated by a photocurable resin and in which bubbles are not generated. In addition, the apparatus may further include a vacuum hole formed in the turntable, which can be opened and closed independently from the opening and closing of a vacuum hole formed in the central axis of the turntable, to prevent the lifting of the optical disc when the cap is removed. As a result, operability and the manufacturing efficiency of the apparatus can be increased significantly.

### CROSS-REFERENCE TO RELATED PATENT APPLICATIONS

This application claims the benefit of Korean Patent Application No. 10-2004-0045475, filed on Jun. 18, 2004, in the Korean Intellectual Property Office, the disclosure of which is incorporated herein in its entirety by reference.

### BACKGROUND OF THE INVENTION

1. Field of the Invention

The present invention relates to an apparatus for optical disc spin-coating, and more particularly, to an apparatus for optical disc spin-coating wherein the leakage of a photocurable resin is prevented by controlling a contact area between an optical disc and a cap.

2. Description of the Related Art

Optical discs are used in optical pickup apparatuses for recording/reproducing information. Examples of optical disc include compact discs (CDs) with a storage capacity of 600 to 800 MB and digital versatile discs (DVDs) with a storage capacity of 4 to 10 GB. Recently, to store more data and achieve higher audio and video quality, blu-ray discs (BDs) or HD-DVDs with a storage capacity of 20 GB or greater have been developed using a 405 nm blue laser technology.

To increase recording density of optical discs, various methods are used. One possibility in this regard is to minimize the size of a light spot, which is achieved by controlling the wavelength of a laser and the number of apertures of a lens according to the following equations:
D∝1.22λ/NA (1)
F∝λ/NA² (2)
f∝A/2NA (3)
where D is the diameter of a spot, λ is the wavelength of a laser, NA is the number of apertures of a lens, F is a focal depth, f is a focal distance, and A is the diameter of a lens.

As shown in equation 1, when the wavelength of a laser decreases and the number of the apertures of a lens increases, the size of the spot decreases, the pit of a disc and the size of a corresponding track decreases, and the record density increases inverse-proportionally to the square of the size of the spot. On the other hand, as shown in the equations 2 and 3, when the wavelength decreases and the number of the apertures increases, the focal depth decreases and the focal distance decreases.

That is, the BD has a light spot of a smaller diameter, smaller focal depth, and smaller focal distance than the DVD, which has a light spot of smaller diameter, smaller focal depth, and smaller focal distance than the CD. As the focal depth and the focal distance decreases, the reproducing characteristics become more dependent on the state of the light incidence surface of the optical disc. Accordingly, the incidence surface must be protected from scratches and variance of the thickness of the optical disc must be very small.

Meanwhile, in a method of manufacturing an optical disc, a light-transmitting layer, a protecting layer, a lacquer layer, and the like are formed by spin coating. The use of spin coating brings about many advantages. For example, a resin that is removed after the spin coating can be re-circulated in the apparatus, and by controlling the time for the spin coating and the viscosity of the resin the light-transmitting layer and the like can have various thicknesses.

FIG. 1 is a graph illustrating the thickness of the light-transmitting layer with respect to the distance between the center of a substrate and a position at which a photocurable resin is discharged onto the substrate. Referring to FIG. 1, the distance varies from 5 to 25 mm and is increased by 5 mm. Numeral ‘31’ denotes the case where the distance is 5 mm, numeral ‘32’ denotes the case where the distance is 10 mm, numeral ‘33’ denotes the case where the distance is 15 mm, numeral ‘34’ denotes the case where the distance is 20 mm, and numeral ‘35’ denotes the case where the distance is 25 mm. As illustrated in FIG. 1, as the position at which a photocurable resin is discharged onto the substrate is closer to the inner circumference of the substrate, the variance of the thickness of the light-transmitting layer decreases. When the discharge position corresponds to the center of the substrate, theoretically, a light-transmitting layer with no thickness variance can be obtained.

In a method of manufacturing a CD, a recording layer and a reflecting layer are formed on a polycarbonate substrate with a thickness of 1.2 mm by sputtering, and then a thin lacquer layer is formed thereon by spin coating to protect the recording layer, reflecting layer, and the like because the focal distance of a laser is too long. Since the thickness of the lacquer layer is as small as 3 to 5 μm, even when a thickness variance occurs, the variance is very low. In addition, a recording or reproducing light enters from the lower portion of the polycarbonate substrate so that even when the thickness of the upper most layer, that is, the lacquer layer, varies, no errors occur during data reproducing. Accordingly, there is no need to discharge the photocurable resin at the center of the optical disc when the lacquer layer is formed by spin coating.

However, in a method of manufacturing a BD with higher integration capacity using a blue laser, since the focal distance is very short while the integrity of data increases, a reflecting layer, a recording layer, and the like are formed on a 1.1 mm thick polycarbonate and then a 0.1 mm thick light-transmitting layer, through which a reproducing light enters, is formed thereon. Accordingly, the reproduction characteristics of the BD are very dependent on the state of the surface and thickness variance of the photo-transmitting layer.

The light-transmitting layer can be formed by attaching a 0.1 mm thick light-transmitting sheet made of polycarbonate using a reduced pressure adhesive or an ultraviolet curable adhesive. In this case, however, a disc is attached to a large sheet and the remaining part is removed, so that the much of the sheet is wasted, the manufacturing costs are increased, and the environment load is increased. Due to these problems, the spin coating is mainly used for the formation of the light-transmitting layer.

As described with reference to FIG. 1, when the spin coating is performed by discharging the photocurable resin circularly at a predetermined position departing from the center of the optical disc, the thickness of the resin layer increases from the center of the optical disc to the outside. When such an increase of the thickness occurs in the BD, data reproducing errors can occur. In order to prevent this problem, the photocurable resin must be discharged at the center of the rotating disc. However, since a conventional optical disc has a hole at its center, another problem occurs, i.e., the photocurable resin can leak into the hole. As a result, many techniques have been developed to prevent the leakage of the photocurable resin into the hole.

For example, Japanese Patent Laid-open Publication No. 1998-289489 discloses a technique in which a center hole of an optical disc is closed using a cap. However, since most part of the inner surface of the cap contacts the surface of the optical disc, the photocurable resin can leak into the interface between the cap and the optical disc by a capillary phenomenon, thus contaminating the central portion of the optical disc. When the photocurable resin leaks, the central portion of the optical disc is stained, which is not desirable in appearance. In addition, when the optical disc is installed in a driver, an error may occur because the driving axis of the driver and the central hole of the optical disc do not match.

In addition, European Patent No. 1378899 discloses a technique in which a seal ring made of Teflon is empolyed along the circumference of a cap to prevent leakage of the photocurable resin. However, even in this case, there is still a small space between an optical disc and the cap due to the structure of the cap, and thus the resin can leak by the capillary phenomenon, thereby the contaminating the disc. The cap is separated from the optical disc at edge by the seal ring and such a separation results in the generation of bubbles when spin coating the photocurable resin.

### SUMMARY OF THE INVENTION

The present invention provides an apparatus for optical disc spin-coating that prevents leakage of a photocurable resin due to a capillary phenomenon by controlling a contact area between a cap and a disc so that contamination of the disc and manufacturing errors do not occur.

According to an aspect of the present invention, there is provided an apparatus for optical disc spin coating including: a cap that has an inner surface separated from an upper surface of an optical disc, an outer surface having a horizontal central portion and extending to the optical disc, an edge that are slanted in a radial direction, and a circumference portion having a radial width of 0.2 to 3 mm; and a turntable that has an optical disc support, which supports the optical disc, a central axis capable of being inserted into a central hole of the optical disc, and a vacuum hole to fix the cap is formed in the central axis.

The cap may have at least a portion contacting the surface of the optical disc.

A tapered protruding portion is formed in a central portion of the lower surface of the cap, and a recess that can be coupled with the tapered protruding portion in a convexo-concave structure is formed in the central axis of the turntable.

The optical disc support of the turntable may include a vacuum hole for fixing the optical disc.

The apparatus may further include an opening and closing device that opens and closes the vacuum hole formed in the optical disc support and operates independently from the opening and closing of the vacuum hole formed in the central axis of the turntable.

### BRIEF DESCRIPTION OF THE DRAWINGS

The above and other features and advantages of the present invention will become more apparent by describing in detail exemplary embodiments thereof with reference to the attached drawings in which:

FIG. 1 is a graph illustrating the thickness of a light-transmitting layer with respect to the distance between the center of a substrate and a position at which a photocurable resin is discharged;

FIG. 2 is a schematic view of an apparatus for optical disc spin-coating according to an embodiment of the present invention;

FIG. 3 is a sectional view of a cap according to an embodiment of the present invention;

FIG. 4 is a schematic view of an apparatus for optical disc spin-coating according to another embodiment of the present invention;

FIG. 5 is a schematic view of an apparatus for optical disc spin-coating used in Example 2; and

FIG. 6 illustrates a conventional cap used in Comparative Example 3.

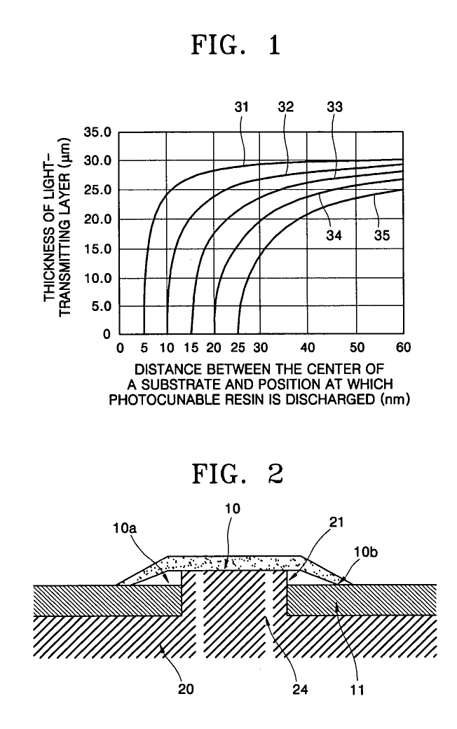

### DETAILED DESCRIPTION OF THE INVENTION

The present invention will now be described more fully with reference to the accompanying drawings.

An apparatus for optical disc spin coating according to an embodiment of the present invention includes a cap that has an inner surface separated from an upper surface of an optical disc, an outer surface having a horizontal central portion and extending to the optical disc, an edge that are slanted in a radial direction, and a circumference portion having a radial width of 0.2 to 3 mm; and a turntable that has an optical disc support, which supports the optical disc, a central axis capable of being inserted into a central hole of the optical disc, and a vacuum hole to fix the cap and is formed in the central axis.

FIG. 2 is a schematic view of an apparatus for optical disc spin coating according to an embodiment of the present invention. A space 10a exists between an inner surface of a cap 10 and an upper surface of an optical disc 11 so that the leakage of a photocurable resin due to a capillary phenomenon can be prevented. In addition, an area 10b where the cap 10 contacts the optical disc 11 has a radial width of 0.2 mm to 3 mm so that the cap 10 is strongly fixed to the optical disc 11 by vacuum pressure, thereby preventing leakage of the photocurable resin due to the capillary phenomenon. When the radial width is less than 0.2 mm, the vacuum pressure for fixing the cap 10 to the disc 11 when spin coating the disc 11 decreases so that the resin can leak between the cap 10 and the optical disc 11. When the radial width is greater than 3.0 mm, the disc contamination resulting from the resin leakage by the capillary phenomenon undesirably increases. Meanwhile, since the outer surface of the cap 10 extends to the upper surface of the optical disc 11, bubbles are prevented from appearing in a space between the circumference of the cap 10 and the upper surface of the optical disc 11 when spin coating the disc 11.

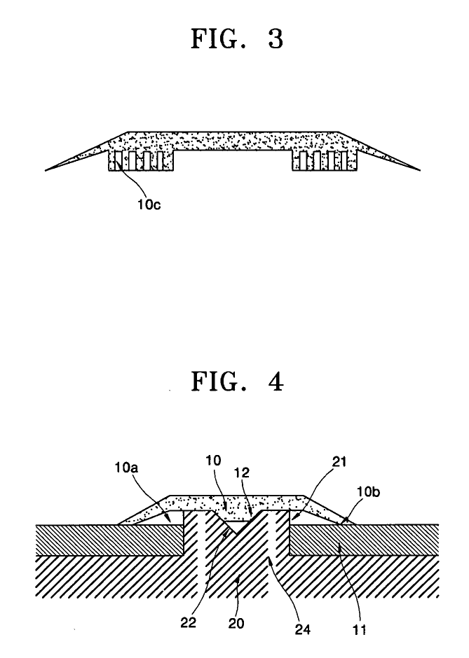

As shown in FIG. 3, the cap 10 may have at least a portion 10c of the inner surface that contacts the surface of the optical disc 11. In the presence of this additional contact portion, the possible resin leakage can be prevented even when the contact surface 10b has an extremely small radial width.

FIG. 4 is a schematic view of an apparatus for optical disc spin coating according to another embodiment of the present invention. A cap 10 has a tapered protruding portion 12 that is formed in a central portion of a lower surface of the cap 10. A turntable 20 has a central axis having a recess 22 into which the protruding portion 12 of the cap 10 is inserted. In detail, the recess 22 is formed such that the cap 10 can be easily inserted thereto or separated therefrom even when the cap 10 is not positioned exactly at the center of the optical disc 11. The tapered protruding portion 12 and the recess 22 may have any shape as long as the protruding portion 12 can be inserted into the recess 22. Meanwhile, the tapered protruding portion 12 of the cap 10 and the recess 22 formed in the central axis 21 of the turntable 20 are inclined at an angle ranging from 30° to 60°. In this case, the cap 10 moves toward the center of the turntable 20 even when the cap 10 is eccentrically placed on the optical disc 11.

In addition, the turntable 20 may further include a vacuum hole 24 in the central axis in order to fix the cap 10. That is, the cap 10 can be completely attached to the surface of the optical disc 11 by vacuum pressure when spin coating the disc, so that the leakage of the photocurable resin can be prevented. In addition, when the tapered protruding portion 12 of the cap 10 and the recess 22 formed in the edge portion of the central axis of the turntable 20 are not coupled precisely in a convexo-concave structure, the tapered protruding portion 12 and the recess 22 can slide along the contact surface by vacuum pressure, so that the cap 10 can easily move toward the center of the turntable 20. The vacuum hole 24 can be formed in another portion of the central axis of the turntable 20 and a plurality of vacuum holes 24 may be formed.

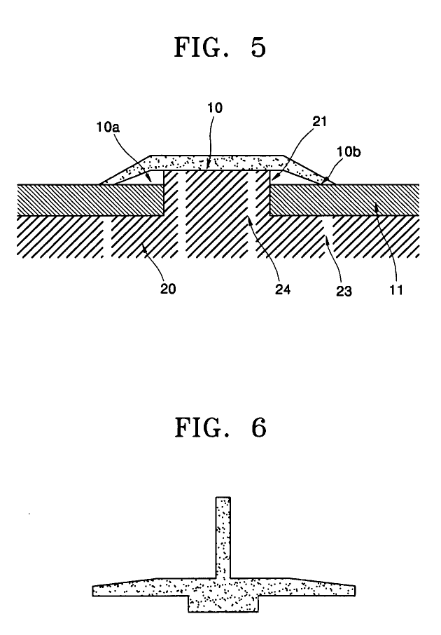

As shown in FIG. 5, the apparatus for optical disc spin coating according to an embodiment of the present invention may further include a vacuum hole 23 to fix the optical disc 11 by vacuum pressure to an optical disc support of the turntable 20. The vacuum hole 23 can be formed in any contact area between the optical disc support and the optical disc 11.

Meanwhile, the apparatus for optical disc spin coating may further include an opening and closing device (not shown) that opens and closes the vacuum hole 23 formed in the optical disc support and operates independently from the opening and closing of the vacuum hole 24 formed in the central axis of the turntable 20. During the spin coating, the cap 10 is fixed to the optical disc 11 by vacuum pressure via the vacuum holes 23 and 24. When the spin coating is completed, only the vacuum pressure of the vacuum hole 23 that fixes the cap 10 is removed while the vacuum pressure of the vacuum hole 24 is maintained. As a result, the cap 10 can be removed from the optical disc 11 without lifting the optical disc 11.

The cap 10 may be formed of a magnetic material that can be removed and attached by magnet, such as a metal or the like, because in general the cap 10 is attached to and removed from using a magnet. For example, the cap 10 may be made of stainless steel or the like. Meanwhile, when a support axis, which can be grabbed, is formed on the upper surface of the cap 10, the cap 10 can be made of a resin, such as polycarbonate or the like. The turntable 20 may be composed of any material that is conventionally used in the art.

The apparatus for optical disc spin coating according to the present invention can be used to manufacture a write once read many (WORM)-type optical disc, an erasable-type optical disc that include a recording layer, a read only memory (ROM) optical disc, and any optical disc including a light-transmitting layer that is formed by spin coating. The apparatus can also be used to form, in addition to the light-transmitting layer, a protecting layer, a middle layer, a lacquer layer, or the like, in order to improve the mechanical characteristics of the optical disc.

A method of spin coating a photocurable resin using the apparatus for optical disc spin coating according to an embodiment of the present invention will now be described.

The optical disc 11 is installed on the turntable 20, and the cap 10 is installed to cover the central hole of the optical disc 11. Then, the cap 10 is attached to the optical disc 11 on the turntable 20 by vacuum pressure via the vacuum holes 23 and 24. Thereafter, the photocurable resin is discharged to the central portion of the cap 10 through a nozzle, and then the turntable 20 starts to rotate when discharging the photocurable resin, the turntable 20 may rotate at a rotation speed of about 20 to 100 rpm, which is a relatively low speed. However, after the resin is completely discharged, the rotation speed is increased in order to form a uniform light-transmitting layer. The rotation speed for the spin coating is closely related to the thickness of the light-transmitting layer to be formed. For example, when the rotation speed is higher, the formed light-transmitting layer is thinner. Meanwhile, the photocurable resin can be any photocurable resin that is commonly used in the art. For example, an acrylate resin is mainly used as the photocurable resin.

After the photocurable resin is spin coated, the cap 10 must be removed. The removing of the cap 10 can be performed before or after the photocurable resin has hardened. However, when the cap 10 is removed after the photocurable resin has hardened, a boundary surface between the cap 10 and the light-transmitting layer can be damaged so that a burr can be formed. Accordingly, preferably, the cap is removed before the photocurable resin has hardened.

The present invention will be described in further detail with reference to the following examples. However, the following examples are for illustrative purposes only and are not intended to limit the scope of the invention.

### EXAMPLE 1

An optical disc was manufactured by first forming a four-layer structure of Ag alloy/ZnS—SiO₂/SbGeTe/ZnS—SiO₂ by sputtering on a projection molded polycarbonate (PC) optical disc substrate with a thickness of 1.1 mm, an outer diameter of 120 mm, and an inner diameter (the diameter of the center hole) of 15 mm. Then, the resultant structure was placed on a turntable as illustrated in FIG. 2, and a cap with an outer surface extending to an upper surface of the structure and a radial width of 0.2 mm was installed thereon. The structure and the cap were fixed by vacuum pressure. Then, an ultra violet curable resin containing EB 8402 (obtained from SK UCB Co., Ltd), Irgacure 184 (obtained from Ciba SC Co., Ltd.), Irgacure 651(obtained from Ciba SC Co., Ltd), and methylethylketone was spin coated to form a light-transmitting layer with a thickness of 100 μm. Then, the cap was detached from the optical disc by removing the vacuum pressure for fixing the optical disc and the cap. Then, UV light was radiated to the resultant product to harden the photocurable resin.

### EXAMPLE 2

An optical disc was manufactured by first forming a four-layer structure of Ag alloy/ZnS—SiO₂/SbGeTe/ZnS—SiO₂ by sputtering on a projection molded polycarbonate (PC) optical disc substrate with a thickness of 1.1 mm, an outer diameter of 120 mm, and an inner diameter (the diameter of the center hole) of 15 mm. Then, the resultant structure was placed on a turntable as illustrated in FIG. 5, and a cap with an outer surface extending to an upper surface of the structure and a radial width of 3.0 mm was installed thereon. Thereafter, the cap and the optical disc were fixed by the vacuum pressure formed by vacuum hole in the central axis and in the turntable. Then, an ultra violet curable resin containing EB 8402 (obtained from SK UCB Co., Ltd), Irgacure 184 (obtained from Ciba SC Co., Ltd.), Irgacure 651(obtained from Ciba SC Co., Ltd), and methylethylketone was spin coated to form a light-transmitting layer with a thickness of 100 μm. Then, the cap was detached from the optical disc by removing the vacuum pressure fixing the cap while the vacuum between the optical disc and the turntable was maintained. After the cap was removed, UV light was radiated to the optical disc to harden the photocurable resin.

### COMPARATIVE EXAMPLE 1

An optical disc was manufactured in the same manner as in Example 1 except that the circumference portion of the cap contacting the upper surface of the optical disc had a radial width of 0.1 mm.

### COMPARATIVE EXAMPLE 2

An optical disc was manufactured in the same manner as in Example 1 except that the circumference portion of the cap contacting the upper surface of the optical disc had a radial width of 4.0 mm.

### COMPARATIVE EXAMPLE 3

An optical disc was manufactured in the same manner as in Example 1, except that, as illustrated in FIG. 6, a conventional cap having an outer surface that was separated from the surface of the optical disc and an inner surface mostly contacting the optical disc was used.

### EXPERIMENTAL EXAMPLE 1

Optical discs manufactured according to Examples 1 and 2 and Comparative Examples 1 through 3 were inspected with the naked eye for disc contamination and bubbles. The results are shown in Table 1.
∘: No contamination in the central portion
Δ: Small contamination in the central portion

x: Significant contamination in the central portion

TABLE 1

| | Contamination | Bubbles |
|---|---|---|
| Example 1 | ◯ | none |
| Example 2 | ◯ | none |
| Comparative Example 1 | Δ | none |
| Comparative Example 2 | Δ | none |
| Comparative Example 3 | X | generated |

According to the present invention, an optical disc having a central portion which is not contaminated by a photocurable resin and at which bubbles are not generated can be manufactured using the apparatus of the present invention. When a cap and a central axis of a turntable of the apparatus have a protruding portion and a recess, respectively, and the protruding portion and the recess can be coupled to each other in a convexo-concave structure, the cap can be easily installed. In addition, when the apparatus further include a vacuum hole formed in the turntable, which can be opened and closed independently from the opening and closing of a vacuum hole formed in the central axis of the turntable, the lifting of the optical disc when the cap is removed can be prevented. As a result, operability and the manufacturing efficiency of the apparatus can be increased significantly.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An apparatus for optical disc spin coating comprising:
a cap that has an inner surface separated from an upper surface of an optical disc, an outer surface having a horizontal central portion and extending to the optical disc, an edge that are slanted in a radial direction, and a circumference portion having a radial width of 0.2 to 3 mm; and
a turntable that has an optical disc support, which supports the optical disc, a central axis capable of being inserted into a central hole of the optical disc, and a vacuum hole to fix the cap and is formed in the central axis.

2. The apparatus of claim 1, wherein the cap comprises at least a portion contacting the surface of the optical disc.

3. The apparatus of claim 1, wherein a tapered protruding portion is formed in a central portion of the lower surface of the cap, and a recess that can be coupled with the tapered protruding portion in a convexo-concave structure is formed in the central axis of the turntable.

4. The apparatus of claim 1, wherein the optical disc support of the turntable comprises a vacuum hole for fixing the optical disc.

5. The apparatus of claim 4, further comprising an opening and closing devcie that opens and closes the vacuum hole formed in the optical disc support and operates independently from the opening and closing of the vacuum hole formed in the central axis of the turntable.
